(19) United States
(12) Patent Application Publication
(10) Pub. No.: US 2023/0229957 A1
(43) Pub. Date: Jul. 20, 2023

(54) SUBCOMPONENT MODEL TRAINING

(71) Applicant: salesforce.com, inc., San Francisco, CA (US)

(72) Inventors: Shuyang Li, San Diego, CA (US); Yingbo Zhou, Palo Alto, CA (US); Semih Yavuz, San Diego, CA (US); Govardana Sachithanandam Ramachandran, Palo Alto, CA (US)

(21) Appl. No.: 17/576,724

(22) Filed: Jan. 14, 2022

(51) Int. Cl. G06N 20/00

(52) U.S. Cl. CPC G06N 20/00

(57) ABSTRACT

Methods, apparatuses, and computer-program products are disclosed. The method may include inputting one or more subcomponent training datasets into the plurality of subcomponent models of the machine learning model, the machine learning model may be configured to perform a final task, and the plurality of subcomponent models may be configured to perform sequential subtasks that result in the final task. The method may include computing one or more weights for data points of the one or more subcomponent training datasets and the one or more weights may be based on a contribution of the data points to an end-to-end error loss measurement associated with performing the final task of the machine learning model. The method may include training the plurality of subcomponent models based on the one or more weights for the data points of the one or more subcomponent training datasets.

### FIELD OF TECHNOLOGY

The present disclosure relates generally to database systems and data processing, and more specifically to subcomponent model training.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, the cloud platform, a server, or other device may train a machine learning model that includes one or more subcomponent models. However, methods for training such machine learning models may be deficient.

### BRIEF DESCRIPTION OF THE DRAWINGS

FIG. 1 illustrates an example of a system that supports subcomponent model training in accordance with examples as disclosed herein.

FIG. 2 illustrates an example of a system that supports subcomponent model training in accordance with examples as disclosed herein.

FIG. 3 illustrates an example of a training scheme that supports subcomponent model training in accordance with examples as disclosed herein.

FIG. 4 illustrates an example of a process flow that supports subcomponent model training in accordance with examples as disclosed herein.

FIG. 5 shows a block diagram of an apparatus that supports subcomponent model training in accordance with examples as disclosed herein.

FIG. 6 shows a block diagram of a training manager that supports subcomponent model training in accordance with examples as disclosed herein.

FIG. 7 shows a diagram of a system including a device that supports subcomponent model training in accordance with examples as disclosed herein.

FIGS. 8 through 10 show flowcharts illustrating methods that support subcomponent model training in accordance with examples as disclosed herein.

### DETAILED DESCRIPTION

Some machine learning models may include one or more subcomponent models. Such subcomponent models may solve sub-problems of the overall problem being addressed by the machine learning models by engaging in sub-tasks. For example, task-oriented dialog systems may aid customers by serving as a conversational interface for interaction. The objective of such a system is to respond in natural language to a user utterance with sufficient information to help the user. One major challenge in developing machine learning models with subcomponent models is the lack of end-to-end data for services of interest. Different services (e.g., customer service returns, travel booking, food ordering) may have different patterns and semantics (e.g., conversational patterns and semantics) and there is often little or no annotated data (e.g., conversation transcripts) for fully supervised training of machine learning models. Instead, there are annotated datasets (sometimes partially or incompletely annotated) for subtasks in various domains that may be unrelated or only tangentially related to the domain relevant to the model being trained. However, current methods to train models (e.g., pre-training, meta-learning) for new services in low data regimes suffer from being bloated and computationally expensive and also suffer from domain mismatches between available training data and the target service.

To reduce or eliminate such weaknesses in machine learning training approaches, the subject matter described herein allows for training of each subcomponent of a machine learning model using subcomponent-specific datasets that are evaluated based on their effect on the machine learning model as a whole. For example, a server or other element tasked with training a machine learning model may utilize one or more subcomponent training datasets and input these datasets into the machine learning model. For example, the server may input such subcomponent datasets into one or more subcomponent models. The server may compute one or more weights for the data points that are included in the subcomponent datasets (e.g., thereby indicating a relative importance or applicability of some data points as compared to other data points). Computations or procedures for computing these weights may be based on how much the data points improve the performance of the machine learning model as a whole, even though the data points are applied to one or more subcomponent models, and not to the machine learning model as a whole. Then, the plurality of subcomponent models may be trained based on the determined or calculated weights for the data points in the subcomponent datasets.

The approaches described herein may further use a “critic” model to train a sub-component of a machine learning model by assigning the weights to the data points in the annotated subtask datasets (also described as “meso” datasets) based on how relevant the data points are at improving the end-to-end (or “meta”) performance of the machine learning model as a whole. The critic may assign weights by comparing the end-to-end performance (e.g., as measured by a meta loss calculation) of the machine learning model before and after applying a meso-update (e.g., an update to a subcomponent of the machine learning model). The critic may then be trained by ranking a set of before and after comparisons to determine weights for the data points. Additionally or alternatively, the critic may be trained based on an expected reward, an expected future reward, an estimated meta gradient, a discount term, or any combination thereof. In this way, the meso datasets applicable to individual subcomponents may be used to train the subcomponents based on their effectiveness at improving the machine learning model as a whole while reducing computational expenses and domain mismatches present in other approaches.

The subject matter described herein may formulate or characterize a problem of training a model with multiple subcomponents as a co-operative heterogeneous multi-agent reinforcement learning problem with a common reward (e.g., performance of the full model on the “meta” end-to-end task). Such a problem may be co-operative because sub-components may co-operate as parts of a larger model for the main task, and heterogeneous because each sub-component may perform a distinct sub-task (e.g. dialog state tracking, response generation).

This common reward may be re-distributed among the agents according to their contribution (e.g., a contribution of a sub-component to the overall model performance), which guides the learned weights (e.g., critic rewards) for data points. To do so, the subject matter described herein may factorize the total Q-function of the end-to-end system (e.g., a main model) as the Q-function of sub-components. Other approaches do not include or contemplate such operations. In some examples, the critic model may be trained using a TD-Lambda critic training formulation. In some such formulations, a system may optimize for an optimal mixture of actions (e.g., a batch of data points) rather than a single action. Such an optimization approach may be apparent in equations (e.g., through the use of expectations in the equations) used to implement such an approach, such as Equation 12.

Aspects of the disclosure are initially described in the context of an environment supporting an on-demand database service. Aspects of the disclosure are then described in the context of a system, a training scheme, and a process flow. Aspects of the disclosure are further illustrated by and described with reference to apparatus diagrams, system diagrams, and flowcharts that relate to subcomponent model training.

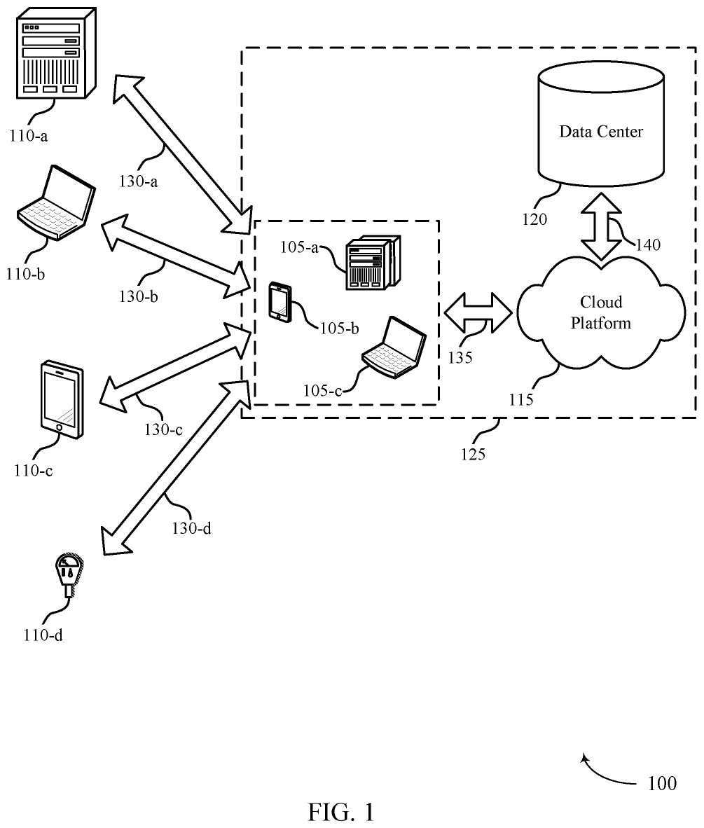

FIG. 1 illustrates an example of a system 100 for cloud computing that supports subcomponent model training in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

In some examples, the cloud platform 105 may train a machine learning model that may be stored at or retrieved from the data center 120. The cloud client 105 may input one or more subcomponent training datasets into one or more subcomponent models of a machine learning model. This machine learning model may be configured to perform one or more sequential tasks (e.g., intent determination in a chatbot) leading up to a final task (e.g., providing a response to a user asking the chatbot a question). The cloud client 105 may compute one or more weights for data points in the subcomponent training datasets. Such weights may represent a relevance, an importance, an applicability, or other metric for classifying, measuring, or selecting data points that improve the performance of the machine learning model as a whole. Such weights may be selected or calculated based on a loss measurement of the machine learning model (e.g., an end-to-end error loss measurement of the machine learning model as a whole, referred to as a meta loss). The cloud client 105 may train the subcomponent models of the machine learning model based on the selected or calculated weights for the data points (e.g., using a critic model for each subcomponent model).

Other methods for training machine learning models may be associated with technical or computational deficiencies. For example, in the context of machine learning models for some tasks such as task-oriented dialog (TOD) agents, there is little or no end-to-end training data for services of interest. Training data that exist for different services (e.g., customer service returns, travel booking, food ordering) have different conversational patterns and semantics, and there is often little or no annotated conversation transcripts for fully supervised training of TOD models. Instead, there exist partially (incompletely) annotated datasets for each sub-task in various domains that may be unrelated or only tangentially related to the TOD domain. Current methods to train models for new services in low data regimes suffer from being bloated and computationally expensive (e.g., pre-training, meta-learning) and the aforementioned domain mismatch between available training data and the target service (e.g., multi-task learning). Further, training models that utilize a general prior or that generalize well to arbitrary downstream tasks may involve the use of exponentially increasing model sizes, which quickly become prohibitively large to use.

The approaches described herein resolve such technical problems. For example, the subject matter described herein allows training of machine learning models (e.g., a task-oriented dialog system) that are more computationally efficient. Further, the approaches allow for training of machine learning models using a wider range of machine learning datasets, such as the large amounts of available, partially/incompletely annotated data from related or orthogonal services (e.g., dialog tasks). In particular, the subject matter described herein includes training one or more sub-components of a machine learning model using sub-component-specific datasets, but in a way that improves the end-to-end or meta performance of the machine learning model as a whole, thereby reducing or eliminating degradation in machine learning models (e.g., in final dialog agents) that are used for training sub-components. Such approaches improve the quality and interpretability of machine learning models and implementations thereof (e.g., conversational agents).

For example, suppose that a user or company wishes to train a task-oriented dialog system to provide assistance to customers by serving as a conversational interface for interaction. One objective of such a system may be to respond in natural language to a user utterance or input with sufficient information to help the user. Such systems may contain sub-components that solve sub-problems of task-oriented dialog such as dialog state tracking (inferring user preferences from utterances), dialog policy (predicting the next action the system should take), and response generation (returning a natural language response to the user). To provide such a service, the user or company may train the individual machine learning models (e.g., meso models) for each of the subcomponents of the overall machine learning model for the task-oriented dialog system by training individual subcomponents based on the effects of updates to the subcomponents on the machine learning model as a whole. For example, the user may train a critic model for each subcomponent of a dialog agent and may train the subcomponents with one or more datasets that are the same as, related to, or unrelated to particular subtasks that the subcomponents perform. For example, a subcomponent for dialog state tracking may be trained using a dataset from a related task of slot filling. Similarly, a subcomponent for dialog policy may be trained using a dataset for intent detection. While training with such data, one or more weights may be assigned to one or more data points of the datasets (e.g., based on how relevant or “helpful” the data point is in improving the machine learning model as a whole). For example, the user or company may employ the use of a critic model that may be learned by computing an end-to-end loss (e.g., a meta loss) of the machine learning model before an update to a subcomponents, performing the update, and subsequently recomputing the end-to-end loss of the machine learning model after the update. By comparing or otherwise processing these loss measurements, a weight may be determined for one or more data points. Then, based on these weights, the subcomponent models may be trained. The user or company may repeat, refine, add to, or modify such procedures to produce further improvements. In this way, a user or company may train a machine learning model by training subcomponents using subcomponent datasets and measuring the effect of the subcomponents on the machine learning model as a whole.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

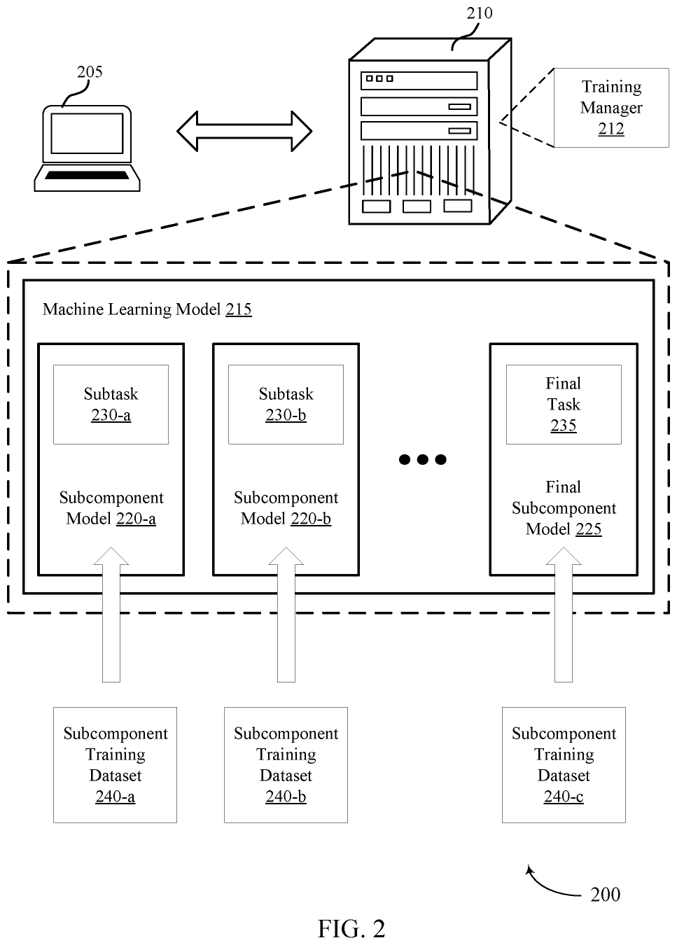

FIG. 2 illustrates an example of a system 200 that supports subcomponent model training in accordance with examples as disclosed herein. The system 200 may include a user device 205 and a server 210. The server 210 may run, configure, or otherwise support a training manager 212 that may perform functions or operations for training a machine learning model 215 as described herein.

The machine learning model 215 may include subcomponent models 220 (e.g., first subcomponent model 220-a and second subcomponent model 220-b) and a final subcomponent model 225. In some examples, subcomponent models 220 may be associated with or perform one or more subtasks 230, including subtask 230-a and subtask 230-b. Further, the final subcomponent model 225 may be associated with or be perform a final task 235.

Many real-world tasks performed by machine learning models (e.g., holding a conversation, making a hotel reservation, or other tasks) may contain one or more subtasks that are performed by individual models in the course of performing the larger, real-world task. In some examples, such subtasks may be sequential subtasks, non-sequential subtasks, or any combination thereof. Examples of such tasks may include task-oriented dialog, knowledge-grounded generation, and end-to-end transcription. In some cases, there may be a lack of data (e.g., fully-supervised data, annotated data, or other data helpful for training machine learning models or subcomponents) for the overall task. However, there may be more data available for the subtasks of the larger task (e.g., partial annotations, orthogonal tasks, related tasks, unrelated tasks, or any combination thereof). As such, the subject matter described herein uses data (e.g., the subcomponent training datasets 240-a, 240-b, and 240-c) to train the individual subcomponent models 220, the final subcomponent model 225, or any combination thereof and bases such training on the effects on the overall machine learning model 215 resulting from updates, additions, deletions, or other modifications to one or more of the subcomponent models 220, the final subcomponent model 225, or any combination thereof. In some examples, the subject matter described herein may be used for learning a task-specific prior.

In some examples, the training manager 212 or other element may input a subcomponent training dataset 240 into subcomponent models 220, the final subcomponent model 225, or any combination thereof. Such subcomponent training datasets 240 may be subcomponent-specific datasets, datasets for end-to-end machine learning models, or any combination thereof. For example, in a context associated with task-oriented dialog, a subcomponent training dataset 240 may be a dataset associated with context, belief states, user intent, dialog acts, responses, slot filling, dialog state tracking, intent detections, dialog, policy, response generation, utterance modeling, other tasks or subtasks, or any combination thereof. In other contexts, the subcomponent training datasets 240 may be associated with other tasks. Further, the subcomponent training dataset 240 may be associated with tasks from a context different from that in which the machine learning model is to operate. In some examples, multiple subcomponent training datasets 240 may be used for a subcomponent model 220. In other examples, arbitrary amounts of data from an arbitrary number of subcomponent training datasets 240 may be employed, and the subject matter described herein may process or utilize some or all such data in the course of operations as described herein.

The subcomponent training datasets 240 may include a distribution of data points, and, in some cases, the training manager 212 may select one or more subcomponent training dataset 240 to achieve a desired distribution of data points formed from a combination of the subcomponent training dataset 240. Additionally or alternatively, the training manager 212 may, as discussed herein, select or calculate weights for data points from the subcomponent training datasets 240 to further select or modify the distribution of data points. For example, if distributions of two subcomponent training datasets 240 overlap, the training manager 212 may weight the data points from the subcomponent training datasets 240 that overlap more heavily to create a richer distribution for use with the machine learning model 215.

In some examples, a subcomponent training dataset 240 may be completely or partially annotated data from related, orthogonal, or unrelated services (e.g., dialog tasks, knowledge-grounded generation tasks, end-to-end transcription tasks, or other tasks). Use of such subcomponent training datasets 240 may allow for training of the subcomponent models 220 and the final subcomponent model 225 with task-specific, task-related, or task-applicable data points while at the same time improving the end to end performance of the machine learning model 215 as a whole. In some examples, such performance may be characterized with an equation, such as Equation 1 below, in which weights associated with data points of the subcomponent training datasets 240 (“meso” data) are updated in order to improve performance on the overall target task (the “meta” task).

min_{θ}Σₜₐₛₖ_{ᵢ} [symbol] _{Meta}(θ−η·∇_{θ} [symbol] _{Meso}(θ,Dᵢ),D^{Meta}) (1)

In some examples, the training manager 212 may compute one or more weights for one or more data points coming from the subcomponent training datasets. A weight assigned to a data point may be interpreted as an importance, a relevance, a utility, or other indication of the data point as it relates to the machine learning model. For example, a relatively high or strong weight may indicate that the data point is relatively helpful or useful for adjusting or updating the machine learning model 215, whereas a data point of relatively low or weak weight may indicate that the data point is unrelated or non-useful for adjusting or updating the machine learning model 215. In some examples, the training manager 212 may determine, calculate, or select the one or more weights based on a contribution of the corresponding data points to an end-to-end measurement of the 215 (e.g., an end-to-end or meta error loss measurement, the measurement described above in relation to Equation 1). For example, if a particular data point significantly alters the machine learning model (e.g., to produce a more accurate result), the weight associated with that data point may be adjusted to a higher or stronger value. Similarly, if a particular data point offers little effect or a harmful effect on the machine learning model 215, the weight may be adjusted to a lower or weaker value. In some examples, the importance weights may be characterized or calculated using an equation, such as Equation 2 below.

$${argmax}_{β} {\sum }_{i = 1}^{n} \frac{{P}_{θ} ( {x}_{i} )}{{P}_{0} ( {x}_{i} )} log {P}_{β} ( {y}_{i} \vert {x}_{i} ) \qquad ( 2 )$$

The training manager 212 may also train the subcomponent models 220, the final subcomponent model 225, or any combination thereof based on the one or more weights assigned, calculated, or selected for the data points of the subcomponent training datasets 240. In some examples, training (and, optionally, additional input of further subcomponent training datasets 240 and assignment, calculation, or selection or weights) may be repeated through multiple iterations to further refine the subcomponent models 220, the final subcomponent model 225, and the overall machine learning model 215. In this way, the individual subcomponents into which the data points are input may be trained based on the results of the machine learning model 215 as a whole.

By employing these approaches, the subject matter described herein produces a prior that is useful for a target downstream task (e.g., end-to-end task-oriented dialog in a service setting), which is difficult or impossible to achieve using other methods for learning task-agnostic priors. Additionally or alternatively, the subject matter described herein may train subcomponents individually using “meso” data that matches or is similar to the sub-task-specific modality, and such “meso” data may be composed together to form a useful downstream machine learning model 215 (e.g., for use in the context of a full task-oriented dialog agent).

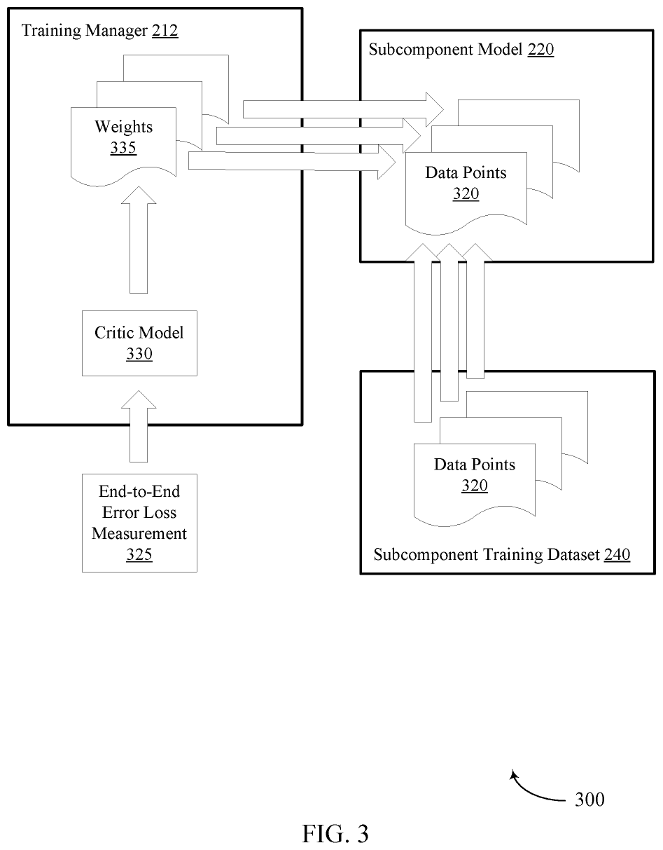

FIG. 3 illustrates an example of a training scheme 300 that supports subcomponent model training in accordance with examples as disclosed herein. The training scheme 300 may include one example of a subcomponent model 220 into which the data points 320 from a subcomponent training dataset 240 are input. As described herein, weights 335 may be applied to or associated with the data points 320. In some examples, a critic model 330 may be learned or trained to calculate, determine, or select the weights 335. In some examples, the training manager 212 may coordinate one or more aspects of the overall training scheme 300 described herein.

In some examples, the training manager 212 may coordinate that training or learning of one or more critic models 330. The critic model 330 may be similar to a critic model used in the context of reinforcement learning. For example, the critic model 330 may be employed to analyze one or more actions to determine a correction, addition, removal, or modification to one or more aspects of the machine learning model. In some examples, a critic model 330 may be trained or learned for each subcomponent training dataset 240. In some examples, such a critic model 330 may be used to assign, calculate, determine, or select the weights 335 that are assigned to or associated with the data points 320, thereby improving the “meta” performance of the machine learning model as a whole. In some examples, an overall learning process involving the use of the critic model 330 may include updating the machine learning model (e.g., one or more subcomponents of the machine learning model) using data points 320 from subcomponent training datasets 240 (e.g., sampled meso-batches) with gradients (or one or more approximations thereof) scaled by output importance weights from the critic model 330, performing a round of second-order gradient estimation with respect to the meta/target task (e.g., the final task 235), updating the critic model 330 to provide new weights to one or more data points 320, and start a new iteration of training. Such a process may be repeated an arbitrary number of times to further refine the machine learning model and the subcomponent training datasets 240.

In some examples, to learn or train the critic model 330, the training manager 212 or other element may compute an end-to-end (e.g., target or “meta”) loss (e.g., the end-to-end error loss measurement 325) of the overall machine learning model before a “meso” update, update the model using a batch of data points 320 (e.g., a “meso” batch, which may include part or all of a subcomponent training dataset 240), and then re-compute the end-to-end or “meta” loss (e.g., the end-to-end error loss measurement 325) of the machine learning model as a whole. The training manager 212 may further take a scaled difference of these losses as a meta gradient (e.g., as opposed to a meso-gradient used in a meso-update). For example, the training manager 212 may employ an approximation of a gradient (e.g., a second-order gradient) instead of calculating an actual gradient, which may be costly in terms of available resources. Such an approximation may replace an expensive calculation, such as a second-order gradient computation. For example, the training manager 212 (or other element) may calculate or determine a finite-difference approximation of a second-order gradient for use in further procedures or aspects as described herein. For example, given a meso learning rate of η, meso gradient updates Gₜ¹ and Gₜ², and a meta loss of L(Gₜ), a meta loss gradient may be approximated by Equation 3 herein.

$$M ( {G}_{t}^{1} ) = \frac{L ( {G}_{\leq t} ) - L ( {G}_{t}^{1} )}{η} \qquad ( 3 )$$

However, such a gradient or approximation thereof may be underspecified (e.g., applies to or is associated with an entire batch of data points 320). Therefore, the critic model 330 may be further trained to learn weights for each individual data point of the data points 320 using multiple methods, or a combination thereof.

A first approach for training the critic model 330 (e.g., to compute weights for individual data points) may be based on an expected reward, an expected future reward, an estimated meta-gradient, a discount term, or any combination thereof. In some examples, the expected reward may be characterized by an equation, such as Equation 4. In some examples, the expected future reward may be characterized by an equation, such as Equation 5. In some examples, the estimated meta gradient may be characterized by an equation, such as Equation 6. In some examples, the discount term may be characterized by an equation, such as Equation 7. In some examples, the term a may correspond or refer to a meso gradient update Gₜ for a batch of meso data (e.g., a group of data points 320).

$$E [ {Q}_{t} ] = {E}_{a \sim U} [ {Q}^{π} ( {s}_{t} , a ) ] \qquad ( 4 )$$

$$E [ {Q}_{t + 1} ] = {E}_{{a}^{′} \sim \frac{{Q}^{π} ( {s}_{t + 1} , a )}{{Σ}_{{a}^{′}} {Q}^{π} ( {s}_{t + 1} , {a}^{′} )}} [ {Q}^{π} ( {s}_{t + 1} , {a}^{′} ) ] \qquad ( 5 )$$

$${R}^{*} = {E}_{a \sim U} [ M ( a ) ] \qquad ( 6 )$$

$$\hat{R} = E [ {Q}_{t} ] - γ \cdot E [ {Q}_{t + 1} ] where 0 \leq γ \leq 1 \qquad ( 7 )$$

In some examples, a loss, such as a TD-λ loss, may be defined or characterized by an equation, such as Equation 8.

TD(λ=0):=(\hat{R}−R*)² (8)

In some examples, a scale of the critic reward \hat{R} may be constrained to fit a scale of the meta gradient R*. As a model learns, the effect of each data point may decrease in magnitude, and thus the critic reward may also decrease in scale. This may cause a model to learn at a slower pace and data points may be weighted with very small scalars. To address this, a method of standardizing the rewards and end-to-end loss gradients in the TD-λ equation may be used to reduce or eliminate such effects (e.g., to make the learned rewards scale-invariant). This allows the model to continue learning with a non-trivial loss, and promotes finer-grained separation between more and less “useful” meso data-points.

Such a standardization method may include various steps, procedures, and operations. Though examples discussed herein have particular orders or combination of steps, procedures, and operations, other orders or combinations are also possible and are contemplated by the subject matter described herein.

In some examples, a standardization approach may include a mean standardization of a critic model 330 (e.g., reward values) and finite difference estimates of the end-to-end loss gradient. For example, such an operation or procedure may be characterized by an equation, such as Equation 9.

$${T D}_{} = {( \frac{\hat{R} - μ ( \hat{R} )}{σ ( \hat{R} )} - \frac{{R}^{*} - μ ( {R}^{*} )}{σ ( {R}^{*} )} )}^{2} \qquad ( 9 )$$

In some examples, a standardization approach may include a regularization (e.g., an L2 regularization) of rewards when their absolute value exceeds one or more thresholds or ranges (e.g., a desired range [−δ, δ]). Such a regularization may be characterized by an equation, such as Equation 10.

[symbol]

_{R}=k_{R}·max(|E[Qₜ]|−δ,0)² (10)

In some examples, a standardization approach may include a sign regularization procedure or operation. Such a procedure or operation may promote or ensure that rewards for a meso batch Bₜ^{c} matches the sign of an end-to-end loss gradient M(Gₜ^{c}).

$${sign}_{} = {k}_{sign} \cdot \frac{max ( - \hat{R} \times {R}^{*} , 0 )}{max ( \vert \hat{R} \times {R}^{*} \vert , ϵ )} \qquad ( 11 )$$

Additionally or alternatively, a ranking approach may also be used that involves a batch ranking approach. Such an approach may learn per-data-point importance weights sampling multiple counter-factual pairs of meso-batches and meta gradients where one meta gradient is larger than the other (e.g., indicating that one meso batch is more useful than another for learning the target task). Then, the critic model 330 may be trained (e.g., using a binary cross-entropy contrastive (ranking) loss). For example, given example meso batches B₁, B₂ and meso gradients (or approximations thereof) Gₜ¹, Gₜ², the contrastive loss [symbol] may be represented by Equation 12, where R(Bᵢ) is expressed as in Equation 13, and P(Gₜ¹ [symbol] Gₜ²) is expressed as in Equation 14.

$${c r i t i c}_{} = - E [ {μ}_{1} log P ( {G}_{t}^{1} ≻ {G}_{t}^{2} ) + {μ}_{2} log P ( {G}_{t}^{1} ≻ {G}_{t}^{2} ) ] \qquad ( 12 )$$

$$R ( {B}_{i} ) = {\sum }_{( {x}_{j} , {y}_{j} ) ∈ {B}_{i}} R ( {x}_{j} , {y}_{j} ) \qquad ( 13 )$$

$${μ}_{1} = \frac{M ( {G}_{t}^{1} )}{M ( {G}_{t}^{1} ) + M ( {G}_{t}^{2} )} \qquad ( 14 )$$

Unlike other meta-learning and importance sampling methods that learn per-dataset, per-task, or per-batch rewards/weights, such an approach to critic model 330 learning or training offers assignment or selection of relevant importance weights on a per-data point basis.

In some examples, a Monte Carlo search approach may be utilized at one or more points in connection with other approaches described herein. In a Monte Carlo search approach, training of the machine learning model may be performed for a number of iterations, after which an analysis of the progress made in those iterations may be performed. This analysis may further be used to train one or more aspects of the machine learning model, the critic model 330, or any combination thereof. Then, the model may be “reset” or “rolled-back” to the point before the number of iterations were performed, and the additional information from the analysis may be incorporated into the training process (e.g., into the critic model 330, the machine learning model, a subcomponent training dataset 240, or any combination thereof). Such an approach may be characterized as a “look-ahead” approach that may aid in the training and learning approaches described herein. For example, a Monte Carlo search approach may determine or select one or more data points 320 for adjustment (e.g., adjustment of one or more weights to emphasize or deemphasize the influence of one or more data points 320).

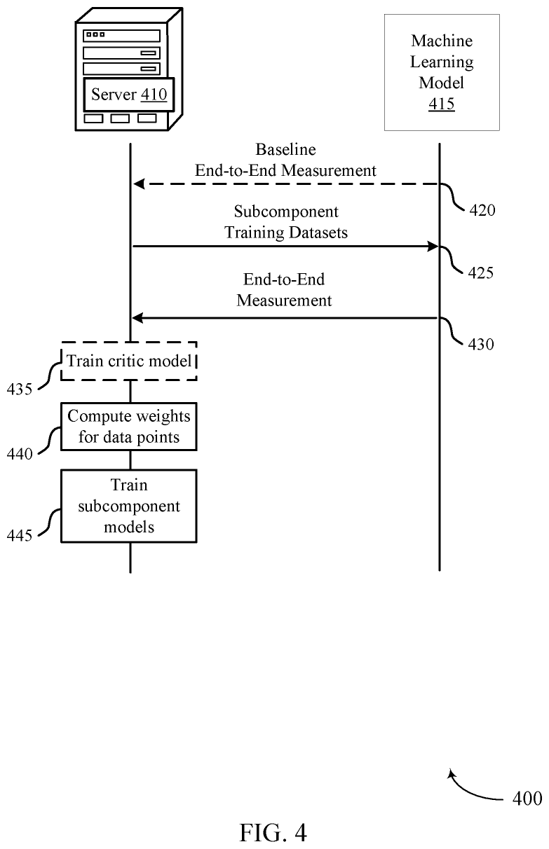

FIG. 4 illustrates an example of a process flow 400 that supports subcomponent model training in accordance with examples as disclosed herein. The process flow 400 may implement various aspects of the present disclosure described with reference to FIGS. 1-4. The process flow 400 may include a server 410 and a machine learning model 415, which may be example of servers and machine learning model 215 as described elsewhere herein.

In the following description of the process flow 400, the operations between the server 410 and the machine learning model 415 may be performed in different orders or at different times. Some operations may also be left out of the process flow 400, or other operations may be added. Although the server 410 and the base machine learning model 415 are shown performing the operations of the process flow 400, some aspects of some operations may also be performed by one or more other devices, programs, entities, other elements, or any combination thereof.

At 420, the server 410 may obtain a baseline end-to-end error loss measurement (e.g., a meta loss measurement) of the machine learning model in a non-updated state.

At 425, the server 410 may input one or more subcomponent training datasets into the plurality of subcomponent models of the machine learning model, wherein the machine learning model is configured to perform a final task and the plurality of subcomponent models are configured to perform sequential subtasks that result in the final task. In some examples, at least one of the one or more subcomponent training datasets may include data points associated with a subtask that is not included in the sequential subtasks.

At 430, the server 410 may obtain the end-to-end error loss measurement based on inputting a first subcomponent training dataset of the one or more subcomponent training datasets into a first subcomponent model of the plurality of subcomponent models. In some examples, the server 410 may calculate a first end-to-end error loss gradient based on the baseline end-to-end error loss measurement and the end-to-end error loss measurement. In some examples, calculating the first end-to-end error loss gradient may include calculating a finite difference approximation based on the baseline end-to-end error loss measurement and the end-to-end error loss measurement.

At 435, the server 410 may train a critic model for the first subcomponent training dataset based on the first end-to-end error loss gradient and a predicted future end-to-end error loss gradient for the first subcomponent training dataset.

Additionally or alternatively, the server 410 may train a critic model for the first subcomponent training dataset based on a ranking between the first end-to-end error loss gradient and a second end-to-end error loss gradient calculated based on the baseline end-to-end error loss measurement and a second end-to-end error loss measurement, wherein the second end-to-end error loss measurement is calculated based on inputting a second subcomponent training dataset of the one or more subcomponent training datasets into the first subcomponent model of the plurality of subcomponent models. In some examples, the second end-to-end error loss gradient is calculated based on a finite different approximation based on the baseline end-to-end error loss measurement and the second end-to-end error loss measurement.

Additionally or alternatively, the server 410 may train a critic model for a first subcomponent training dataset of the one or more subcomponent training datasets. In some examples, the server 410 may train the critic model based on the end-to-end error loss measurement. In some examples, the server 410 may retrain the plurality of subcomponent models based on the updated one or more weights.

At 440, the server 410 may compute one or more weights for data points of the one or more subcomponent training datasets, wherein the one or more weights are based on a contribution of the data points to an end-to-end error loss measurement associated with performing the final task of the machine learning model. In some examples, computing the one or more weights is based on the critic model. In some examples, the server 410 may update the critic model based on the end-to-end error loss measurement. In some examples, the server 410 may update the one or more weights based on the updated critic model.

At 445, the server 410 may train the plurality of subcomponent models based on the one or more weights for the data points of the one or more subcomponent training datasets. Additionally or alternatively, the server 410 may train the plurality of subcomponent models based on a Monte Carlo tree search.

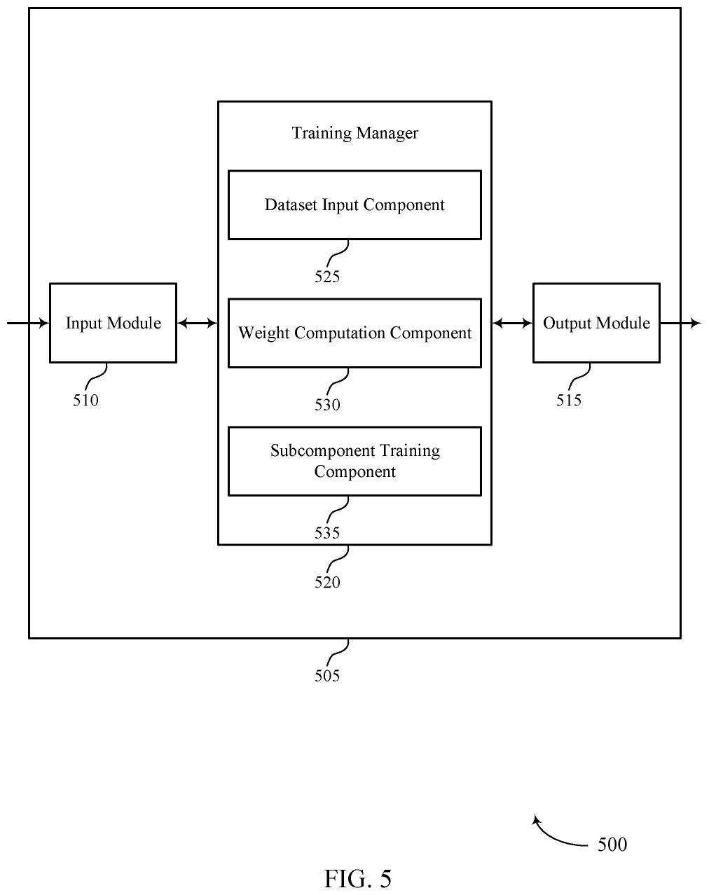

FIG. 5 shows a block diagram 500 of a device 505 that supports subcomponent model training in accordance with examples as disclosed herein. The device 505 may include an input module 510, an output module 515, and a training manager 520. The device 505 may also include a processor. Each of these components may be in communication with one another (e.g., via one or more buses).

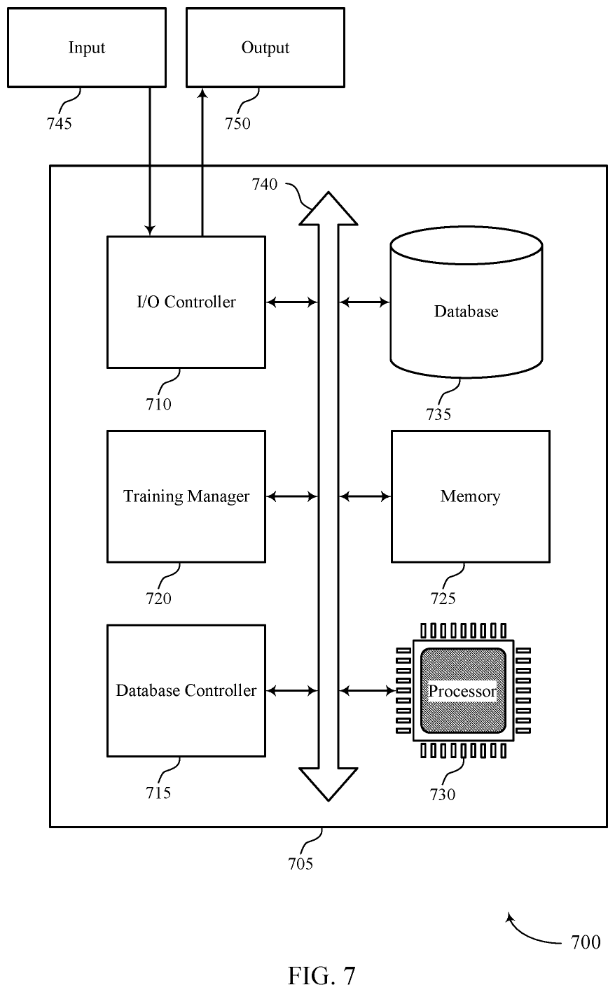

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the training manager 520 to support subcomponent model training. In some cases, the input module 510 may be a component of an I/O controller 710 as described with reference to FIG. 7.

The output module 515 may manage output signals for the device 505. For example, the output module 515 may receive signals from other components of the device 505, such as the training manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the training manager 520 may include a dataset input component 525, a weight computation component 530, a subcomponent training component 535, or any combination thereof. In some examples, the training manager 520, or various components thereof, may be configured to perform various operations (e.g., receiving, monitoring, transmitting) using or otherwise in cooperation with the input module 510, the output module 515, or both. For example, the training manager 520 may receive information from the input module 510, send information to the output module 515, or be integrated in combination with the input module 510, the output module 515, or both to receive information, transmit information, or perform various other operations as described herein.

The training manager 520 may support training a plurality of subcomponent models of a machine learning model in accordance with examples as disclosed herein. The dataset input component 525 may be configured as or otherwise support a means for inputting one or more subcomponent training datasets into the plurality of subcomponent models of the machine learning model, wherein the machine learning model is configured to perform a final task and the plurality of subcomponent models are configured to perform sequential subtasks that result in the final task. The weight computation component 530 may be configured as or otherwise support a means for computing one or more weights for data points of the one or more subcomponent training datasets, wherein the one or more weights are based at least in part on a contribution of the data points to an end-to-end error loss measurement associated with performing the final task of the machine learning model. The subcomponent training component 535 may be configured as or otherwise support a means for training the plurality of subcomponent models based at least in part on the one or more weights for the data points of the one or more subcomponent training datasets.

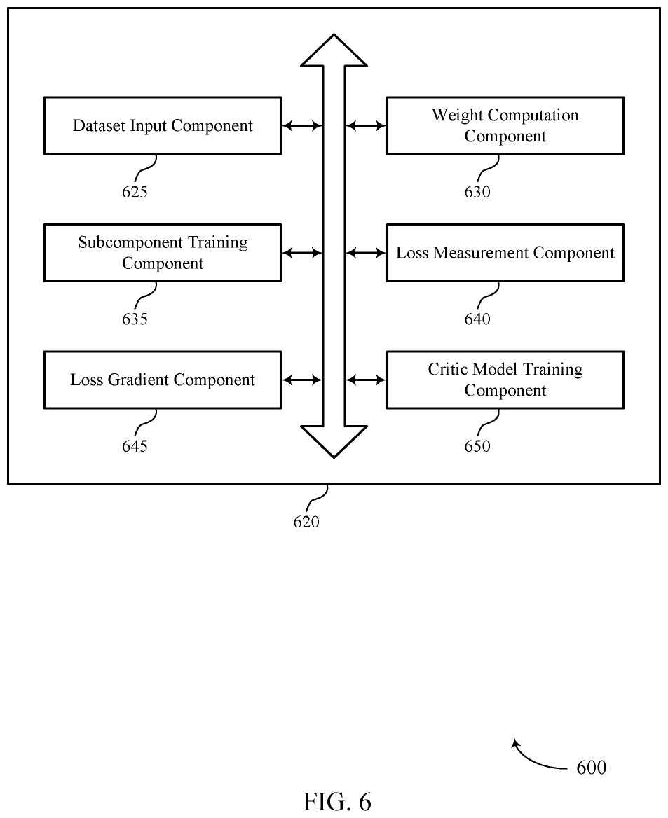

FIG. 6 shows a block diagram 600 of a training manager 620 that supports subcomponent model training in accordance with examples as disclosed herein. The training manager 620 may be an example of aspects of a training manager or a training manager 520, or both, as described herein. The training manager 620, or various components thereof, may be an example of means for performing various aspects of subcomponent model training as described herein. For example, the training manager 620 may include a dataset input component 625, a weight computation component 630, a subcomponent training component 635, a loss measurement component 640, a loss gradient component 645, a critic model training component 650, or any combination thereof. Each of these components may communicate, directly or indirectly, with one another (e.g., via one or more buses).

The training manager 620 may support training a plurality of subcomponent models of a machine learning model in accordance with examples as disclosed herein. The dataset input component 625 may be configured as or otherwise support a means for inputting one or more subcomponent training datasets into the plurality of subcomponent models of the machine learning model, wherein the machine learning model is configured to perform a final task and the plurality of subcomponent models are configured to perform sequential subtasks that result in the final task. The weight computation component 630 may be configured as or otherwise support a means for computing one or more weights for data points of the one or more subcomponent training datasets, wherein the one or more weights are based at least in part on a contribution of the data points to an end-to-end error loss measurement associated with performing the final task of the machine learning model. The subcomponent training component 635 may be configured as or otherwise support a means for training the plurality of subcomponent models based at least in part on the one or more weights for the data points of the one or more subcomponent training datasets.

In some examples, the loss measurement component 640 may be configured as or otherwise support a means for obtaining a baseline end-to-end error loss measurement of the machine learning model in a non-updated state. In some examples, the loss measurement component 640 may be configured as or otherwise support a means for obtaining the end-to-end error loss measurement based at least in part on inputting a first subcomponent training dataset of the one or more subcomponent training datasets into a first subcomponent model of the plurality of subcomponent models. In some examples, the loss gradient component 645 may be configured as or otherwise support a means for calculating a first end-to-end error loss gradient based at least in part on the baseline end-to-end error loss measurement and the end-to-end error loss measurement.

In some examples, calculating the first end-to-end error loss gradient comprises calculating a finite difference approximation based at least in part on the baseline end-to-end error loss measurement and the end-to-end error loss measurement.

In some examples, the critic model training component 650 may be configured as or otherwise support a means for training a critic model for the first subcomponent training dataset based at least in part on the first end-to-end error loss gradient and a predicted future end-to-end error loss gradient for the first subcomponent training dataset. In some examples, the weight computation component 630 may be configured as or otherwise support a means for computing the one or more weights based at least in part on the critic model.

In some examples, the critic model training component 650 may be configured as or otherwise support a means for training a critic model for the first subcomponent training dataset based at least in part on a ranking between the first end-to-end error loss gradient and a second end-to-end error loss gradient calculated based at least in part on the baseline end-to-end error loss measurement and a second end-to-end error loss measurement, wherein the second end-to-end error loss measurement is calculated based at least in part on inputting a second subcomponent training dataset of the one or more subcomponent training datasets into the first subcomponent model of the plurality of subcomponent models. In some examples, the weight computation component 630 may be configured as or otherwise support a means for computing the one or more weights based at least in part on the critic model.

In some examples, the second end-to-end error loss gradient is calculated based at least in part on a finite different approximation based at least in part on the baseline end-to-end error loss measurement and the second end-to-end error loss measurement.

In some examples, the critic model training component 650 may be configured as or otherwise support a means for training a critic model for a first subcomponent training dataset of the one or more subcomponent training datasets. In some examples, the critic model training component 650 may be configured as or otherwise support a means for updating the critic model based at least in part on the end-to-end error loss measurement. In some examples, the weight computation component 630 may be configured as or otherwise support a means for updating the one or more weights based at least in part on the updated critic model. In some examples, the subcomponent training component 635 may be configured as or otherwise support a means for retraining the plurality of subcomponent models based at least in part on the updated one or more weights.

In some examples, the subcomponent training component 635 may be configured as or otherwise support a means for training the plurality of subcomponent models based at least in part on a Monte Carlo tree search.

In some examples, at least one of the one or more subcomponent training datasets comprises data points associated with a subtask that is not included in the sequential subtasks.

FIG. 7 shows a diagram of a system 700 including a device 705 that supports subcomponent model training in accordance with examples as disclosed herein. The device 705 may be an example of or include the components of a device 505 as described herein. The device 705 may include components for bi-directional data communications including components for transmitting and receiving communications, such as a training manager 720, an I/O controller 710, a database controller 715, a memory 725, a processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and ROM. The memory 725 may store computer-readable, computer-executable software including instructions that, when executed, cause the processor 730 to perform various functions described herein. In some cases, the memory 725 may contain, among other things, a BIOS which may control basic hardware or software operation such as the interaction with peripheral components or devices.

The processor 730 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting subcomponent model training).

The training manager 720 may support training a plurality of subcomponent models of a machine learning model in accordance with examples as disclosed herein. For example, the training manager 720 may be configured as or otherwise support a means for inputting one or more subcomponent training datasets into the plurality of subcomponent models of the machine learning model, wherein the machine learning model is configured to perform a final task and the plurality of subcomponent models are configured to perform sequential subtasks that result in the final task. The training manager 720 may be configured as or otherwise support a means for computing one or more weights for data points of the one or more subcomponent training datasets, wherein the one or more weights are based at least in part on a contribution of the data points to an end-to-end error loss measurement associated with performing the final task of the machine learning model. The training manager 720 may be configured as or otherwise support a means for training the plurality of subcomponent models based at least in part on the one or more weights for the data points of the one or more subcomponent training datasets.

By including or configuring the training manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or a combination thereof.

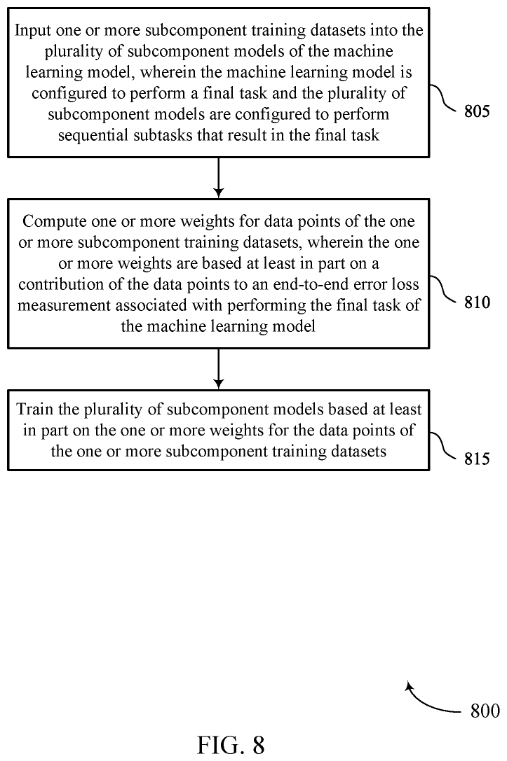

FIG. 8 shows a flowchart illustrating a method 800 that supports subcomponent model training in accordance with examples as disclosed herein. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 805, the method may include inputting one or more subcomponent training datasets into the plurality of subcomponent models of the machine learning model, wherein the machine learning model is configured to perform a final task and the plurality of subcomponent models are configured to perform sequential subtasks that result in the final task. The operations of 805 may be performed in accordance with examples as disclosed herein. In some examples, aspects of the operations of 805 may be performed by a dataset input component 625 as described with reference to FIG. 6.

At 810, the method may include computing one or more weights for data points of the one or more subcomponent training datasets, wherein the one or more weights are based at least in part on a contribution of the data points to an end-to-end error loss measurement associated with performing the final task of the machine learning model. The operations of 810 may be performed in accordance with examples as disclosed herein. In some examples, aspects of the operations of 810 may be performed by a weight computation component 630 as described with reference to FIG. 6.

At 815, the method may include training the plurality of subcomponent models based at least in part on the one or more weights for the data points of the one or more subcomponent training datasets. The operations of 815 may be performed in accordance with examples as disclosed herein. In some examples, aspects of the operations of 815 may be performed by a subcomponent training component 635 as described with reference to FIG. 6.

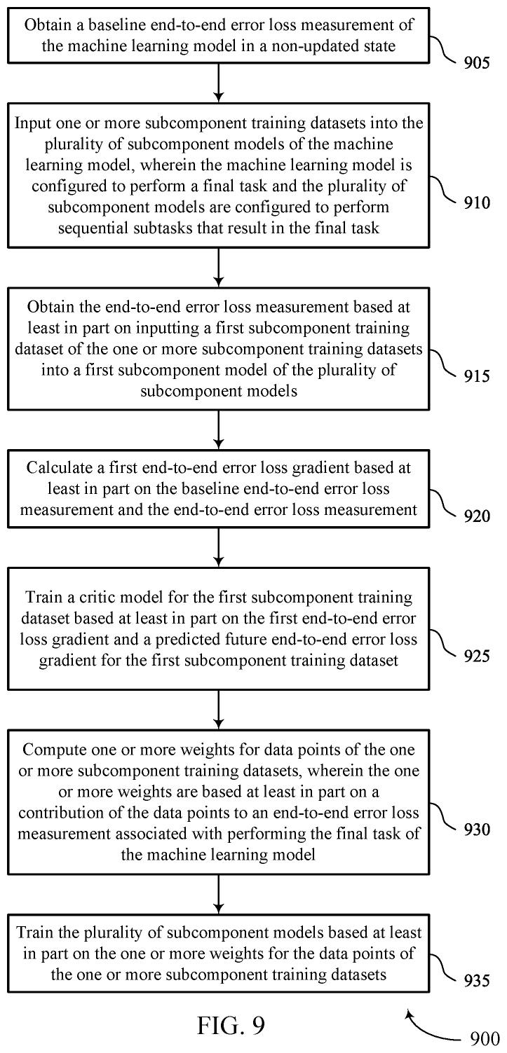

FIG. 9 shows a flowchart illustrating a method 900 that supports subcomponent model training in accordance with examples as disclosed herein. The operations of the method 900 may be implemented by an application server or its components as described herein. For example, the operations of the method 900 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 905, the method may include obtaining a baseline end-to-end error loss measurement of the machine learning model in a non-updated state. The operations of 905 may be performed in accordance with examples as disclosed herein. In some examples, aspects of the operations of 905 may be performed by a loss measurement component 640 as described with reference to FIG. 6.

At 910, the method may include inputting one or more subcomponent training datasets into the plurality of subcomponent models of the machine learning model, wherein the machine learning model is configured to perform a final task and the plurality of subcomponent models are configured to perform sequential subtasks that result in the final task. The operations of 910 may be performed in accordance with examples as disclosed herein. In some examples, aspects of the operations of 910 may be performed by a dataset input component 625 as described with reference to FIG. 6.

At 915, the method may include obtaining the end-to-end error loss measurement based at least in part on inputting a first subcomponent training dataset of the one or more subcomponent training datasets into a first subcomponent model of the plurality of subcomponent models. The operations of 915 may be performed in accordance with examples as disclosed herein. In some examples, aspects of the operations of 915 may be performed by a loss measurement component 640 as described with reference to FIG. 6.

At 920, the method may include calculating a first end-to-end error loss gradient based at least in part on the baseline end-to-end error loss measurement and the end-to-end error loss measurement. The operations of 920 may be performed in accordance with examples as disclosed herein. In some examples, aspects of the operations of 920 may be performed by a loss gradient component 645 as described with reference to FIG. 6.

At 925, the method may include training a critic model for the first subcomponent training dataset based at least in part on the first end-to-end error loss gradient and a predicted future end-to-end error loss gradient for the first subcomponent training dataset. The operations of 925 may be performed in accordance with examples as disclosed herein. In some examples, aspects of the operations of 925 may be performed by a critic model training component 650 as described with reference to FIG. 6.

At 930, the method may include computing one or more weights for data points of the one or more subcomponent training datasets, wherein the one or more weights are based at least in part on a contribution of the data points to an end-to-end error loss measurement associated with performing the final task of the machine learning model. The operations of 930 may be performed in accordance with examples as disclosed herein. In some examples, aspects of the operations of 930 may be performed by a weight computation component 630 as described with reference to FIG. 6.

At 935, the method may include training the plurality of subcomponent models based at least in part on the one or more weights for the data points of the one or more subcomponent training datasets. The operations of 935 may be performed in accordance with examples as disclosed herein. In some examples, aspects of the operations of 935 may be performed by a subcomponent training component 635 as described with reference to FIG. 6.

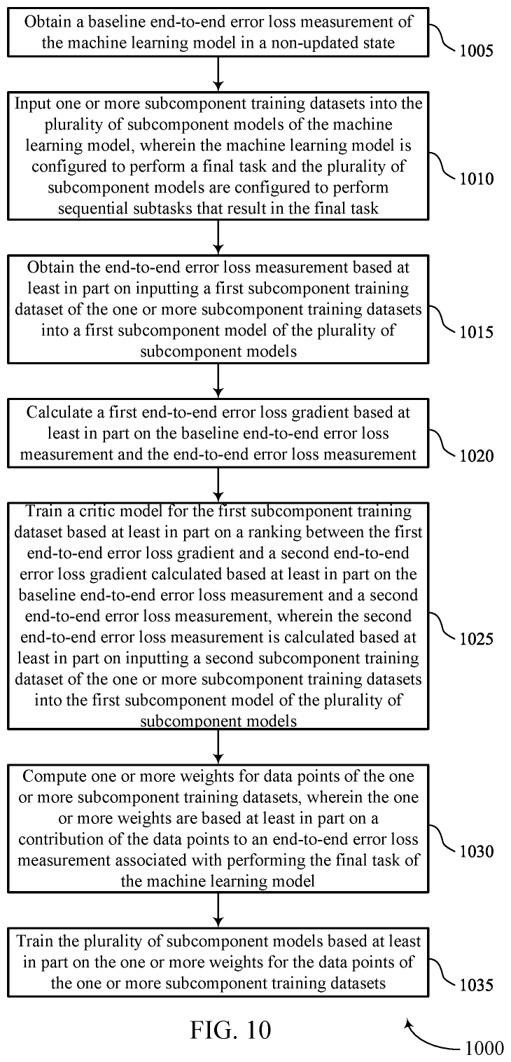

FIG. 10 shows a flowchart illustrating a method 1000 that supports subcomponent model training in accordance with examples as disclosed herein. The operations of the method 1000 may be implemented by an application server or its components as described herein. For example, the operations of the method 1000 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 1005, the method may include obtaining a baseline end-to-end error loss measurement of the machine learning model in a non-updated state. The operations of 1005 may be performed in accordance with examples as disclosed herein. In some examples, aspects of the operations of 1005 may be performed by a loss measurement component 640 as described with reference to FIG. 6.

At 1010, the method may include inputting one or more subcomponent training datasets into the plurality of subcomponent models of the machine learning model, wherein the machine learning model is configured to perform a final task and the plurality of subcomponent models are configured to perform sequential subtasks that result in the final task. The operations of 1010 may be performed in accordance with examples as disclosed herein. In some examples, aspects of the operations of 1010 may be performed by a dataset input component 625 as described with reference to FIG. 6.

At 1015, the method may include obtaining the end-to-end error loss measurement based at least in part on inputting a first subcomponent training dataset of the one or more subcomponent training datasets into a first subcomponent model of the plurality of subcomponent models. The operations of 1015 may be performed in accordance with examples as disclosed herein. In some examples, aspects of the operations of 1015 may be performed by a loss measurement component 640 as described with reference to FIG. 6.

At 1020, the method may include calculating a first end-to-end error loss gradient based at least in part on the baseline end-to-end error loss measurement and the end-to-end error loss measurement. The operations of 1020 may be performed in accordance with examples as disclosed herein. In some examples, aspects of the operations of 1020 may be performed by a loss gradient component 645 as described with reference to FIG. 6.

At 1025, the method may include training a critic model for the first subcomponent training dataset based at least in part on a ranking between the first end-to-end error loss gradient and a second end-to-end error loss gradient calculated based at least in part on the baseline end-to-end error loss measurement and a second end-to-end error loss measurement, wherein the second end-to-end error loss measurement is calculated based at least in part on inputting a second subcomponent training dataset of the one or more subcomponent training datasets into the first subcomponent model of the plurality of subcomponent models. The operations of 1025 may be performed in accordance with examples as disclosed herein. In some examples, aspects of the operations of 1025 may be performed by a critic model training component 650 as described with reference to FIG. 6.

At 1030, the method may include computing one or more weights for data points of the one or more subcomponent training datasets, wherein the one or more weights are based at least in part on a contribution of the data points to an end-to-end error loss measurement associated with performing the final task of the machine learning model. The operations of 1030 may be performed in accordance with examples as disclosed herein. In some examples, aspects of the operations of 1030 may be performed by a weight computation component 630 as described with reference to FIG. 6.

At 1035, the method may include training the plurality of subcomponent models based at least in part on the one or more weights for the data points of the one or more subcomponent training datasets. The operations of 1035 may be performed in accordance with examples as disclosed herein. In some examples, aspects of the operations of 1035 may be performed by a subcomponent training component 635 as described with reference to FIG. 6.

A method for training a plurality of subcomponent models of a machine learning model is described. The method may include inputting one or more subcomponent training datasets into the plurality of subcomponent models of the machine learning model, wherein the machine learning model is configured to perform a final task and the plurality of subcomponent models are configured to perform sequential subtasks that result in the final task, computing one or more weights for data points of the one or more subcomponent training datasets, wherein the one or more weights are based at least in part on a contribution of the data points to an end-to-end error loss measurement associated with performing the final task of the machine learning model, and training the plurality of subcomponent models based at least in part on the one or more weights for the data points of the one or more subcomponent training datasets.

An apparatus for training a plurality of subcomponent models of a machine learning model is described. The apparatus may include a processor, memory coupled with the processor, and instructions stored in the memory. The instructions may be executable by the processor to cause the apparatus to input one or more subcomponent training datasets into the plurality of subcomponent models of the machine learning model, wherein the machine learning model is configured to perform a final task and the plurality of subcomponent models are configured to perform sequential subtasks that result in the final task, compute one or more weights for data points of the one or more subcomponent training datasets, wherein the one or more weights are based at least in part on a contribution of the data points to an end-to-end error loss measurement associated with performing the final task of the machine learning model, and train the plurality of subcomponent models based at least in part on the one or more weights for the data points of the one or more subcomponent training datasets.

Another apparatus for training a plurality of subcomponent models of a machine learning model is described. The apparatus may include means for inputting one or more subcomponent training datasets into the plurality of subcomponent models of the machine learning model, wherein the machine learning model is configured to perform a final task and the plurality of subcomponent models are configured to perform sequential subtasks that result in the final task, means for computing one or more weights for data points of the one or more subcomponent training datasets, wherein the one or more weights are based at least in part on a contribution of the data points to an end-to-end error loss measurement associated with performing the final task of the machine learning model, and means for training the plurality of subcomponent models based at least in part on the one or more weights for the data points of the one or more subcomponent training datasets.

A non-transitory computer-readable medium storing code for training a plurality of subcomponent models of a machine learning model is described. The code may include instructions executable by a processor to input one or more subcomponent training datasets into the plurality of subcomponent models of the machine learning model, wherein the machine learning model is configured to perform a final task and the plurality of subcomponent models are configured to perform sequential subtasks that result in the final task, compute one or more weights for data points of the one or more subcomponent training datasets, wherein the one or more weights are based at least in part on a contribution of the data points to an end-to-end error loss measurement associated with performing the final task of the machine learning model, and train the plurality of subcomponent models based at least in part on the one or more weights for the data points of the one or more subcomponent training datasets.

Some examples of the method, apparatuses, and non-transitory computer-readable medium described herein may further include operations, features, means, or instructions for obtaining a baseline end-to-end error loss measurement of the machine learning model in a non-updated state, obtaining the end-to-end error loss measurement based at least in part on inputting a first subcomponent training dataset of the one or more subcomponent training datasets into a first subcomponent model of the plurality of subcomponent models, and calculating a first end-to-end error loss gradient based at least in part on the baseline end-to-end error loss measurement and the end-to-end error loss measurement.

Some examples of the method, apparatuses, and non-transitory computer-readable medium described herein may further include operations, features, means, or instructions for calculating the first end-to-end error loss gradient comprises calculating a finite difference approximation based at least in part on the baseline end-to-end error loss measurement and the end-to-end error loss measurement.

Some examples of the method, apparatuses, and non-transitory computer-readable medium described herein may further include operations, features, means, or instructions for training a critic model for the first subcomponent training dataset based at least in part on the first end-to-end error loss gradient and a predicted future end-to-end error loss gradient for the first subcomponent training dataset and wherein computing the one or more weights may be based at least in part on the critic model.

Some examples of the method, apparatuses, and non-transitory computer-readable medium described herein may further include operations, features, means, or instructions for training a critic model for the first subcomponent training dataset based at least in part on a ranking between the first end-to-end error loss gradient and a second end-to-end error loss gradient calculated based at least in part on the baseline end-to-end error loss measurement and a second end-to-end error loss measurement, wherein the second end-to-end error loss measurement may be calculated based at least in part on inputting a second subcomponent training dataset of the one or more subcomponent training datasets into the first subcomponent model of the plurality of subcomponent models and wherein computing the one or more weights may be based at least in part on the critic model.

In some examples of the method, apparatuses, and non-transitory computer-readable medium described herein, the second end-to-end error loss gradient may be calculated based at least in part on a finite different approximation based at least in part on the baseline end-to-end error loss measurement and the second end-to-end error loss measurement.

Some examples of the method, apparatuses, and non-transitory computer-readable medium described herein may further include operations, features, means, or instructions for training a critic model for a first subcomponent training dataset of the one or more subcomponent training datasets, updating the critic model based at least in part on the end-to-end error loss measurement, updating the one or more weights based at least in part on the updated critic model, and retraining the plurality of subcomponent models based at least in part on the updated one or more weights.

Some examples of the method, apparatuses, and non-transitory computer-readable medium described herein may further include operations, features, means, or instructions for training the plurality of subcomponent models based at least in part on a Monte Carlo tree search.

In some examples of the method, apparatuses, and non-transitory computer-readable medium described herein, at least one of the one or more subcomponent training datasets comprises data points associated with a subtask that may be not included in the sequential subtasks.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for training a plurality of subcomponent models of a machine learning model, the method comprising:
inputting one or more subcomponent training datasets into the plurality of subcomponent models of the machine learning model, wherein the machine learning model is configured to perform a final task and the plurality of subcomponent models are configured to perform sequential subtasks that result in the final task;
computing one or more weights for data points of the one or more subcomponent training datasets, wherein the one or more weights are based at least in part on a contribution of the data points to an end-to-end error loss measurement associated with performing the final task of the machine learning model; and
training the plurality of subcomponent models based at least in part on the one or more weights for the data points of the one or more subcomponent training datasets.

2. The method of claim 1, further comprising:
obtaining a baseline end-to-end error loss measurement of the machine learning model in a non-updated state;
obtaining the end-to-end error loss measurement based at least in part on inputting a first subcomponent training dataset of the one or more subcomponent training datasets into a first subcomponent model of the plurality of subcomponent models; and
calculating a first end-to-end error loss gradient based at least in part on the baseline end-to-end error loss measurement and the end-to-end error loss measurement.

3. The method of claim 2, wherein calculating the first end-to-end error loss gradient comprises calculating a finite difference approximation based at least in part on the baseline end-to-end error loss measurement and the end-to-end error loss measurement.

4. The method of claim 2, further comprising:
training a critic model for the first subcomponent training dataset based at least in part on the first end-to-end error loss gradient and a predicted future end-to-end error loss gradient for the first subcomponent training dataset;
wherein computing the one or more weights is based at least in part on the critic model.

5. The method of claim 2, further comprising:
training a critic model for the first subcomponent training dataset based at least in part on a ranking between the first end-to-end error loss gradient and a second end-to-end error loss gradient calculated based at least in part on the baseline end-to-end error loss measurement and a second end-to-end error loss measurement, wherein the second end-to-end error loss measurement is calculated based at least in part on inputting a second subcomponent training dataset of the one or more subcomponent training datasets into the first subcomponent model of the plurality of subcomponent models;
wherein computing the one or more weights is based at least in part on the critic model.

6. The method of claim 5, wherein the second end-to-end error loss gradient is calculated based at least in part on a finite different approximation based at least in part on the baseline end-to-end error loss measurement and the second end-to-end error loss measurement.

7. The method of claim 1, further comprising:
training a critic model for a first subcomponent training dataset of the one or more subcomponent training datasets;
updating the critic model based at least in part on the end-to-end error loss measurement;
updating the one or more weights based at least in part on the updated critic model; and
retraining the plurality of subcomponent models based at least in part on the updated one or more weights.

8. The method of claim 1, further comprising:
training the plurality of subcomponent models based at least in part on a Monte Carlo tree search.

9. The method of claim 1, wherein at least one of the one or more subcomponent training datasets comprises data points associated with a subtask that is not included in the sequential subtasks.

10. An apparatus for training a plurality of subcomponent models of a machine learning model, comprising:
a processor;
memory coupled with the processor; and
instructions stored in the memory and executable by the processor to cause the apparatus to:
input one or more subcomponent training datasets into the plurality of subcomponent models of the machine learning model, wherein the machine learning model is configured to perform a final task and the plurality of subcomponent models are configured to perform sequential subtasks that result in the final task;
compute one or more weights for data points of the one or more subcomponent training datasets, wherein the one or more weights are based at least in part on a contribution of the data points to an end-to-end error loss measurement associated with performing the final task of the machine learning model; and
train the plurality of subcomponent models based at least in part on the one or more weights for the data points of the one or more subcomponent training datasets.

11. The apparatus of claim 10, wherein the instructions are further executable by the processor to cause the apparatus to:
obtain a baseline end-to-end error loss measurement of the machine learning model in a non-updated state;
obtain the end-to-end error loss measurement based at least in part on inputting a first subcomponent training dataset of the one or more subcomponent training datasets into a first subcomponent model of the plurality of subcomponent models; and
calculate a first end-to-end error loss gradient based at least in part on the baseline end-to-end error loss measurement and the end-to-end error loss measurement.

12. The apparatus of claim 11, wherein calculating the first end-to-end error loss gradient comprises calculating a finite difference approximation based at least in part on the baseline end-to-end error loss measurement and the end-to-end error loss measurement.

13. The apparatus of claim 11, wherein the instructions are further executable by the processor to cause the apparatus to:
train a critic model for the first subcomponent training dataset based at least in part on the first end-to-end error loss gradient and a predicted future end-to-end error loss gradient for the first subcomponent training dataset;
wherein compute the one or more weights is based at least in part on the critic model.

14. The apparatus of claim 11, wherein the instructions are further executable by the processor to cause the apparatus to:
train a critic model for the first subcomponent training dataset based at least in part on a ranking between the first end-to-end error loss gradient and a second end-to-end error loss gradient calculated based at least in part on the baseline end-to-end error loss measurement and a second end-to-end error loss measurement, wherein the second end-to-end error loss measurement is calculated based at least in part on inputting a second subcomponent training dataset of the one or more subcomponent training datasets into the first subcomponent model of the plurality of subcomponent models;
wherein compute the one or more weights is based at least in part on the critic model.

15. The apparatus of claim 14, wherein the second end-to-end error loss gradient is calculated based at least in part on a finite different approximation based at least in part on the baseline end-to-end error loss measurement and the second end-to-end error loss measurement.

16. The apparatus of claim 10, wherein the instructions are further executable by the processor to cause the apparatus to:
train a critic model for a first subcomponent training dataset of the one or more subcomponent training datasets;
update the critic model based at least in part on the end-to-end error loss measurement;
update the one or more weights based at least in part on the updated critic model; and
retrain the plurality of subcomponent models based at least in part on the updated one or more weights.

17. The apparatus of claim 10, wherein the instructions are further executable by the processor to cause the apparatus to:
train the plurality of subcomponent models based at least in part on a Monte Carlo tree search.

18. The apparatus of claim 10, wherein at least one of the one or more subcomponent training datasets comprises data points associated with a subtask that is not included in the sequential subtasks.

19. A non-transitory computer-readable medium storing code for training a plurality of subcomponent models of a machine learning model, the code comprising instructions executable by a processor to:
input one or more subcomponent training datasets into the plurality of subcomponent models of the machine learning model, wherein the machine learning model is configured to perform a final task and the plurality of subcomponent models are configured to perform sequential subtasks that result in the final task;
compute one or more weights for data points of the one or more subcomponent training datasets, wherein the one or more weights are based at least in part on a contribution of the data points to an end-to-end error loss measurement associated with performing the final task of the machine learning model; and
train the plurality of subcomponent models based at least in part on the one or more weights for the data points of the one or more subcomponent training datasets.

20. The non-transitory computer-readable medium of claim 19, wherein the instructions are further executable by the processor to:
obtain a baseline end-to-end error loss measurement of the machine learning model in a non-updated state;
obtain the end-to-end error loss measurement based at least in part on inputting a first subcomponent training dataset of the one or more subcomponent training datasets into a first subcomponent model of the plurality of subcomponent models; and
calculate a first end-to-end error loss gradient based at least in part on the baseline end-to-end error loss measurement and the end-to-end error loss measurement.
